(19) United States
(12) Patent Application Publication
(10) Pub. No.: US 2008/0168257 A1
(43) Pub. Date: Jul. 10, 2008

(54) Interface assembly for coupling a host to multiple storage devices

(76) Inventors: Glenn Lawrence Marks, Corona, CA (US); Terry G. Sutherland, Lake Forrest, CA (US); Sean R. Lever, Irvine, CA (US); James P. Young, Laguna Niguel, CA (US)

Correspondence Address: SILICON / BLAKELY;BLAKELY SOKOLOFF TAYLOR & ZAFMAN, 1279 OAKMEAD PARKWAY, SUNNYVALE, CA, 94085-4040, US

(21) Appl. No.: 11/650,224

(22) Filed: Jan. 5, 2007

(51) Int. Cl. G06F 9/40

(52) U.S. Cl. 712/38

(57) ABSTRACT

In some embodiments, a storage processor interface assembly includes a circuit board supporting a storage processor, first and second standard compliant power connectors, and first, second, and third standard compliant data connectors. The second power connector and the second data connector are positioned such that they may mate with corresponding standard compliant power and data connectors on a storage device. The storage processor is capable of operating with the second and third data connectors in at least one of a mirrored memory mode and a storage expansion mode. Other embodiments are described and claimed.

### BACKGROUND

1. Technical Field

Embodiments of the present inventions relate to a storage processor interface assembly for coupling a host to multiple storage devices, and to related systems and methods. In some embodiments, the storage processor interface assembly includes a circuit board supporting Serial Advanced Technology Attachment (SATA) compatible connectors.

2. Background Art

Storage systems often use multiple disk drives to provide features such as fault tolerance, increased throughput, increased storage capacity, and expandability. For example, mirroring uses two or more drives to store duplicate copies of data such that if one of the drives fails the data can still be read from another drive. Striping allows data to be divided into portions that are written (and read) in parallel to two or more drives at the same time to provide increased throughput. Concatenation combines two or more drives to enable a higher storage capacity than would be available from a single disk drive. While such features have become common in enterprise-class storage solutions, these features are still rare among consumer systems. The cost and complexity of assembling such systems prevents many consumers from being able to take advantage of these advanced storage features.

Design limitations of commodity, consumer-level storage hardware also prevent users from benefiting from these advanced storage features. For example, many computer systems limit the number of disk drives that can be addressed by a single host interface. A Serial Advanced Technology Attachment (SATA) 1.0 specification is available at www.serialata.org. A later SATA II Port Multiplier specification (available at www.serialata.org) added an additional addressing scheme that allows a host to address 15 physical disk drives, but not all hosts support the newer specification, and having the host computer system manage multiple drives involves additional complexity and configuration that is difficult for many consumers. A Serial ATA International Organization: Serial ATA Revision 2.5, 27 Oct. 2005 (available at www.serialata.org) is a revision of earlier SATA specifications and includes information about a SATA port multiplier in, for example, chapter 16. The net result is that the consumer is not able to obtain easy-to-use, low-cost hardware capable of providing high-end storage features available to enterprise-class computer systems.

### SUMMARY

In some embodiments, a storage processor interface assembly includes a circuit board supporting a storage processor, first and second standard compliant power connectors, and first, second, and third standard compliant data connectors. The second power connector and the second data connector are positioned such that they may mate with corresponding standard compliant power and data connectors on a storage device. The storage processor is capable of operating with the second and third data connectors in at least one of a mirrored memory mode and a storage expansion mode.

In other embodiments, a storage processor interface assembly includes an enclosure to hold a circuit board coupled to a storage processor and first, second, and third standard compliant data connectors, wherein the enclosure includes openings such that the first, second, and third connectors are available to be mated with connectors of cables outside the enclosure. The storage processor is capable of operating with the second and third data connectors in at least one of a mirrored memory mode and a storage expansion mode. The only data signal interfaces to the enclosure are the three data connectors.

In still other embodiments, a storage processor interface assembly includes an enclosure to hold a circuit board coupled to a storage processor and first, second, and third standard compliant data connectors, wherein the enclosure includes openings such that the first, second, and third connectors are available to be mated with connectors of cables outside the enclosure. The storage processor is capable of operating with the second and third data connectors in at least one of a mirrored memory mode and a storage expansion mode. The enclosure has length dimensions that are less than 100 millimeters by 100 millimeters by 200 millimeters.

Further embodiments are described and claimed.

### BRIEF DESCRIPTION OF THE DRAWINGS

The inventions will be understood more fully from the detailed description given below and from the accompanying drawings of embodiments of the inventions which, however, should not be taken to limit the inventions to the specific embodiments described, but are for explanation and understanding only.

FIG. 1 is a block diagram representation of a system including a storage processor interface assembly coupled between a host computer and first and second storage devices.

FIG. 2 is a block diagram representation of details of a storage processor of FIG. 1.

FIG. 3 is a block diagram representation of a system including storage processor interface assemblies coupled to storage devices.

FIG. 4 is a block diagram representation of a system including a storage processor interface assembly coupled between a host computer and first and second storage devices.

FIG. 5 is a block diagram representation of a system including storage processor interface assemblies coupled to storage devices.

FIG. 6 is an isometric view of a storage processor interface assembly attached to a hard disc drive.

FIG. 7 is a top view of the storage processor interface assembly of FIG. 6.

FIG. 8 is a plan view of the storage processor interface assembly of FIG. 6.

FIG. 9 is an edge view of the storage processor interface assembly of FIG. 6.

FIG. 10 is an isometric view of a storage processor interface assembly attached to a hard disc drive.

FIG. 11 is a plan view of the storage processor interface assembly and hard disc drive of FIG. 10.

FIG. 12 is a plan view of the storage processor interface assembly and hard disc drive of FIG. 10 from a view opposite that of FIG. 11.

FIG. 13 is a side view of the storage processor interface assembly and hard disc drive of FIG. 10.

FIGS. 14-16 are each an isometric view of a storage processor interface assembly attached to a hard disc drive.

FIG. 17 is an isometric view an enclosure receiving cables.

FIG. 18 is an isometric view of storage processor interface assembly that may be included in the enclosures of FIG. 17 and FIG. 19, or other enclosures.

FIG. 19 is an isometric view an enclosure receiving cables.

FIG. 20 is an isometric view of storage processor interface assembly that may be included in the enclosures of FIG. 17 and FIG. 19, or other enclosures.

FIGS. 21-24 are different views of the storage processor interface assembly of FIG. 20.

FIGS. 25-28 are each an isometric view of storage processor interface assembly that may be included in the enclosures of FIG. 17 and FIG. 19, or other enclosures.

### DETAILED DESCRIPTION

Embodiments of the present inventions relate to a storage processor interface assembly for coupling a host to multiple storage devices, and to related systems and methods. In some embodiments, the storage processor interface assembly includes a circuit board supporting Serial Advanced Technology Attachment (SATA) compatible connectors that connect with SATA compatible connectors on, for example, a 3.5 inch disc drive. In other embodiments, the storage processor interface assembly includes an enclosure and includes one SATA data connector to interface with a host and two SATA data connectors to interface with storage devices, or a storage device and another storage processor interface assembly. As used herein, the term “data” may include address and command signals as well as more traditional data signals.

As used herein, the term SATA compatible connector means a connector that meets the requirements for the particular type of connector as described in one or more SATA specifications including current and future SATA specifications. The connectors may be compatible with internal or external (eSATA) SATA specifications. In some embodiments, the connectors are compatible with one or more other standards, but not a SATA standard. In still other embodiments, the connectors are compatible with one or more other standards and also with one or more SATA standards.

In some embodiments, the storage processor interface assembly operates in a mirrored memory mode in which data signals are provided to two storage devices in a mirrored fashion. As an example, the mirroring may be according to a RAID 1 mirroring protocol. In other embodiments, the storage processor interface assembly operates in a storage expansion mode in which two storage devices are presented to the host as a single storage device which has the combined storage of the two storage devices. In still other embodiments, the storage processor interface assembly can be configured to operate in either the mirrored memory mode or the storage expansion mode. In still other embodiments, the storage processor interface assembly can be configured to operate in some other mode such as a striping mode, or combination of the mirrored memory mode and storage expansion mode, for example, where a portion of storage device is used for mirroring and another portion for expansion.

A. System Overview

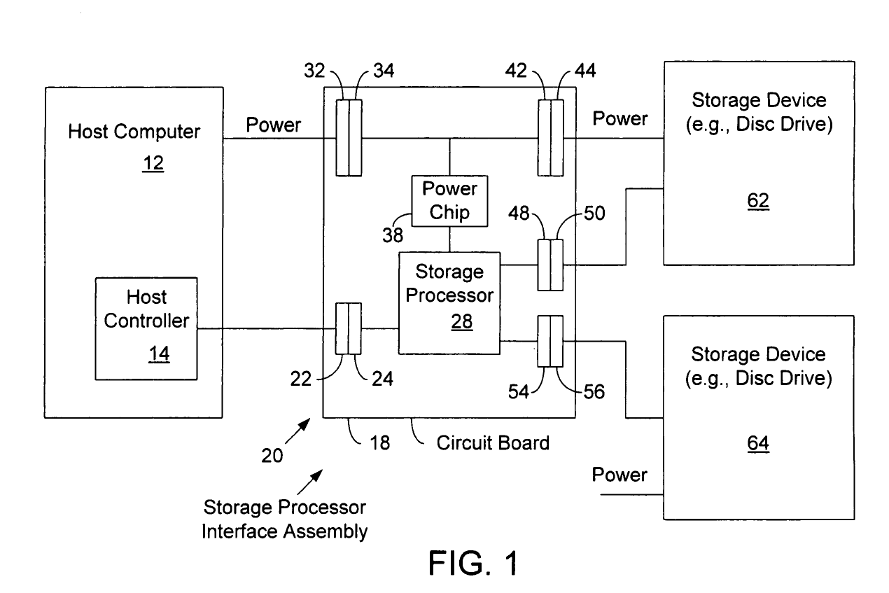

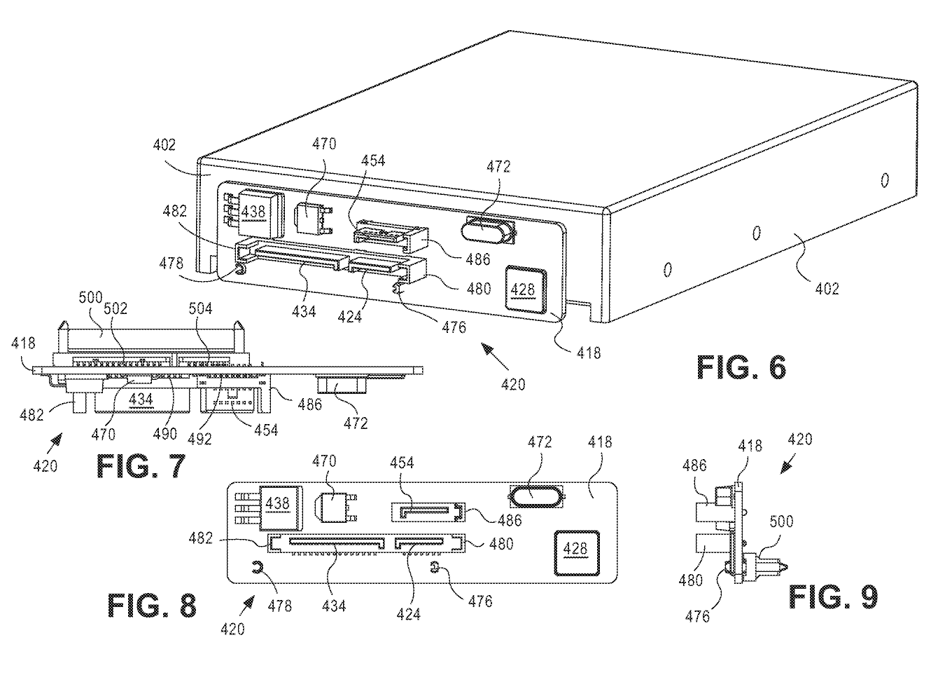

Referring to FIG. 1, a host computer 12 include a host controller 14. In ordinary systems, host controller 14 would be coupled directly to storage device 62. However, in FIG. 1, a storage processor interface assembly 20 is positioned between host controller 14 and storage device 62. Storage processor interface assembly 20 may be used as shown in FIGS. 6-16. Referring to FIG. 1, storage processor interface assembly 20 includes connectors 24, 34, 42, 48, and 54 supported by a circuit board 18. Connector 24 is shown mated with connector 22 that carries data signals from host controller 14. As an example, connector 24 may be a male SATA data segment connector and connector 22 may be a female SATA data connector. Data signals are provided from connector 24 to storage processor 28. Storage processor 28 provides the data signals from connector 24 to connector 48 and/or to connector 54 as described below. Storage processor 28 may be a single integrated circuit chip or more than a single chip. Connectors 48 and 54 are shown mated with connectors 50 and 56. Connectors 48 and 54 may be female SATA data segment connectors. Connector 50 may be a male SATA data segment connector and may be part of storage device 62, and connector 56 may be a male SATA data segment connector and may be part of storage device 64.

Connector 34 is shown mated with connector 32 which carries power signals from host computer 12 or from some other power source. As an example, connector 34 may be a male SATA power segment connector and connector 32 may be a female SATA power connector. The power signals from connector 34 are provided to a power chip 38 and to a connector 42, which is shown mated with connector 44. Connector 42 may be a female SATA power segment connector and connector 44 may be a male SATA power connector that may be part of storage device 62. Power chip 38 provides power signals to storage processor 28. In some embodiments, assembly 20 includes more than one power chip.

Storage devices 62 and 64 each may be a hard disc drive, an optical drive, or some other type of mass storage device. Storage devices 62 and/or 64 may be considered part of host computer 12 or separate from it. Storage devices 62 and 64 may be commodity, low cost devices or more specialty, higher priced storage devices. Storage devices 62 and 64 may be storage devices used in a computer system, or a digital video recorder (DVR), or in another system. Storage device 62 may be internal or external to the computer system or DVR or other system. Storage device 64 may be internal or external to the computer system or DVR or other system.

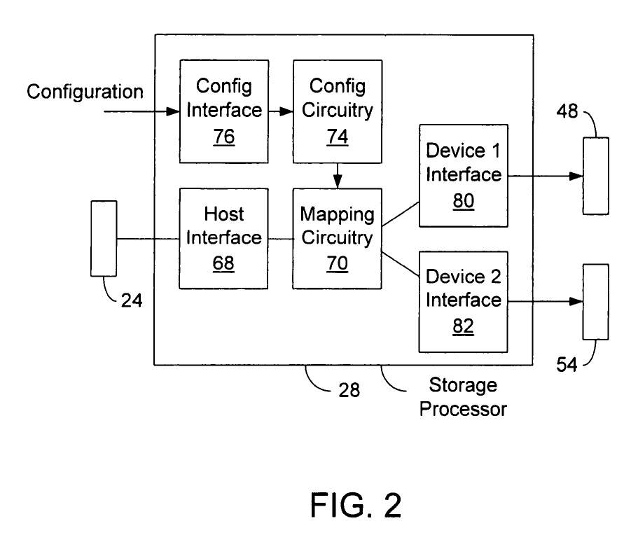

There are many ways in which storage processor 28 may be implemented, and the inventions are not restricted to one particular way. FIG. 2 illustrates details that may be included in some of the implementations of storage processor 28, but other embodiments of the storage processor 28 do not include some of these details. Referring to FIG. 2, host interface 68 receives data signals from connector 24 and provides the signals to mapping circuitry 70. Mapping circuitry 70 provides data signals to device 1 interface and/or to device 2 interface 82 according to a protocol that is at least partly controlled by a configuration signal from configuration circuitry 74. Data also passes from the storage devices to the host computer through storage processor 28. In some embodiments, storage processor 28 uses firmware and in other embodiments, it does not. In some embodiments, the configuration can be changed through a signal to configuration interface 76 that is provided to configuration circuitry 74. In some implementations, mapping circuitry 70 may be considered as providing a virtual to physical data mapping.

As an example, if storage processor 28 is in a mirrored memory mode, data is provided to both device 1 interface 80 and to device 2 interface 82, which are coupled to connectors 48 and 54. If storage processor 28 is in a storage expansion mode, mapping circuitry 70 provides data to either device 1 interface 80 or to device 2 interface in such a way as to cause storage devices 62 and 64 to act as one large storage device. In some embodiments, in the storage expansion mode, the operation is transparent to a user of host computer 12 in that the operating system of host computer 12 only sees only one large storage device.

The configuration may be permanent or changeable. The configuration may be established through various means. For example, the configuration information may be provided through commands through data connector 24. The configuration information may be provided through hardware pins or jumpers, or by flashing a particular firmware image to the system during manufacturing. The system may use a policy table to specify configuration information in the form of behavior directives. When control logic within the device reaches a decision point and must select a course of action from multiple possibilities, the table may be consulted and the action specified by the table is performed. This allows the same hardware to be used to expose different features simply by modifying the contents of the policy table. Hardware pins may also be provided that override particular policies in the policy table to allow for additional configurability without modifying the policy table.

FIG. 1 shows the storage processor 28 interfacing between one input data connector and two output data connectors. Alternatively, a different version of storage processor 28 could interface between one input data connector and three or more output data connectors. Storage processor interface assemblies may be in series or concatenated in a hierarchical fashion. For example, in FIG. 3, a storage processor interface assembly 120 is coupled to connector 54 of storage processor interface assembly 20 through connectors 56 and 122. Storage processor interface assembly 120 may be identical to or different than storage processor interface assembly 20. Storage processor interface assembly 120 includes connectors 124, 134, 142, 148, and 154 supported by a circuit board 118. Connector 124 is shown mated with connector 122 that carries data signals from storage processor interface assembly 20. Data signals are provided from connector 124 to storage processor 128. Storage processor 128 provides the data signals from connector 124 to connector 48 and/or to connector 54 depending on the protocol. Connectors 148 and 154 are shown mated with connectors 150 and 156. Connector 150 may be part of storage device 162. Connector 156 may be part of storage device or storage processor interface assembly 164.

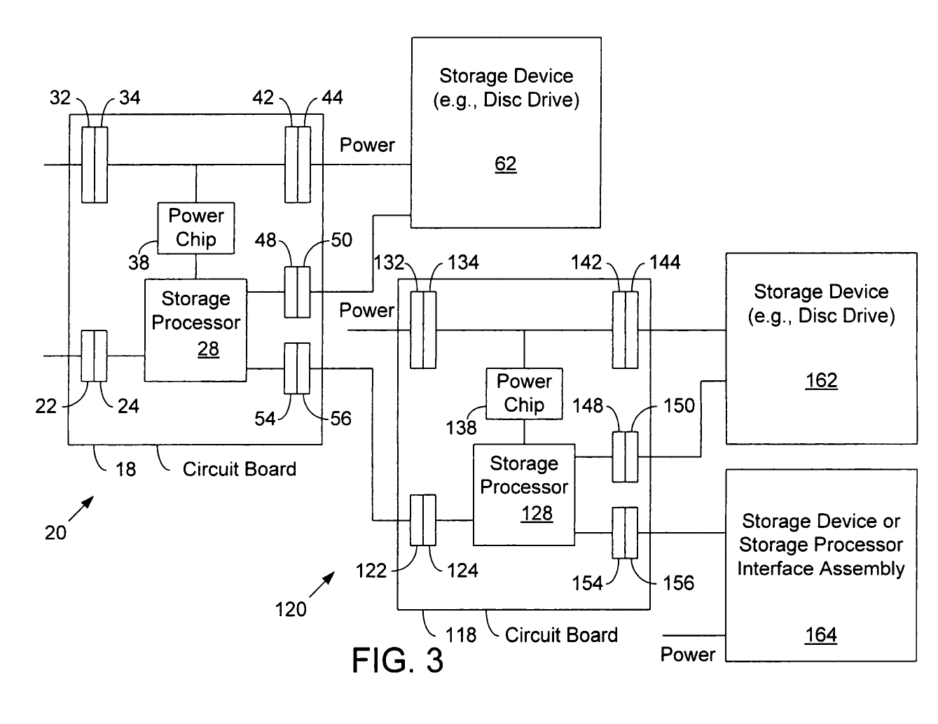

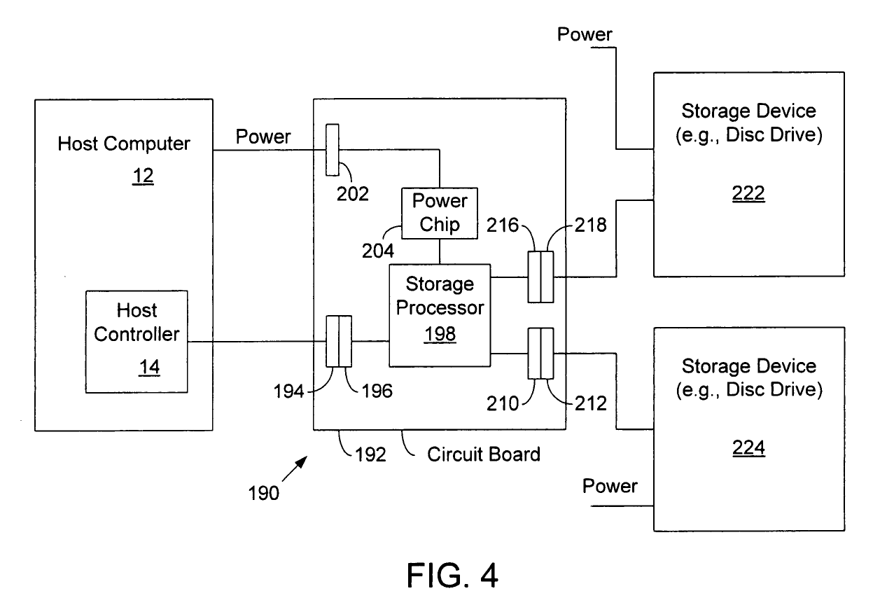

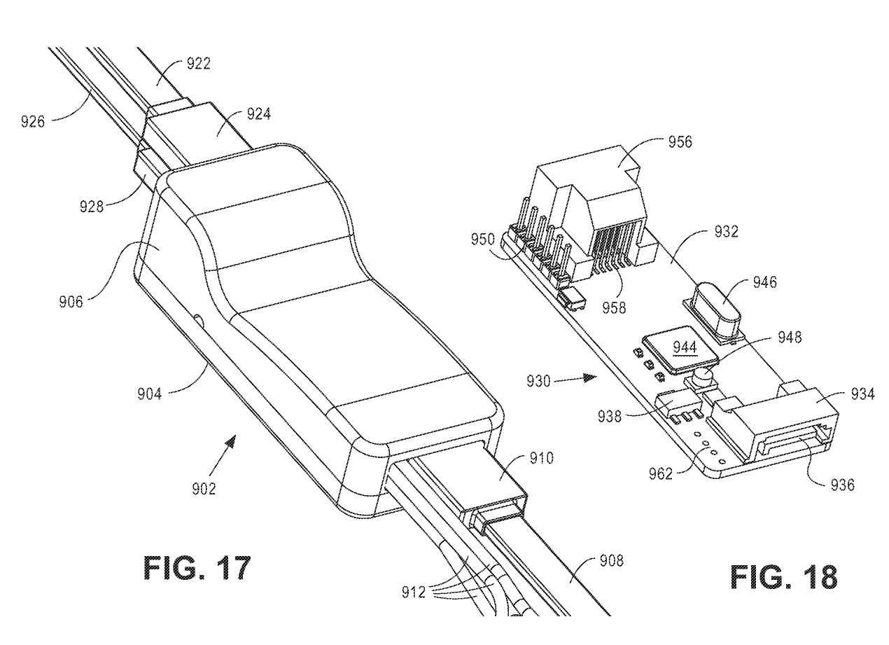

FIG. 4 illustrates a system which is similar to that of FIG. 1 except that power to the storage device 222 is not provided from storage processor interface assembly 190. A storage processor interface assembly 190 may be used as shown in FIGS. 17-28. Alternatively, storage processor interface assembly 190 could be mounted to a storage device.

Referring to FIG. 4, storage processor interface assembly 190 includes connectors 196, 202, 216, and 210 supported by a circuit board 18. Connectors 196, 216, and 210 may be SATA data connectors. Connectors 218 and 212 may be male SATA data connectors that are part of storage devices 222 and 224. Connector 202 may be pins or other receivers for power lines. Storage processor 198 and power chip 204 may be the same as or different than power chip 38 and storage processor 28 and power chip 38.

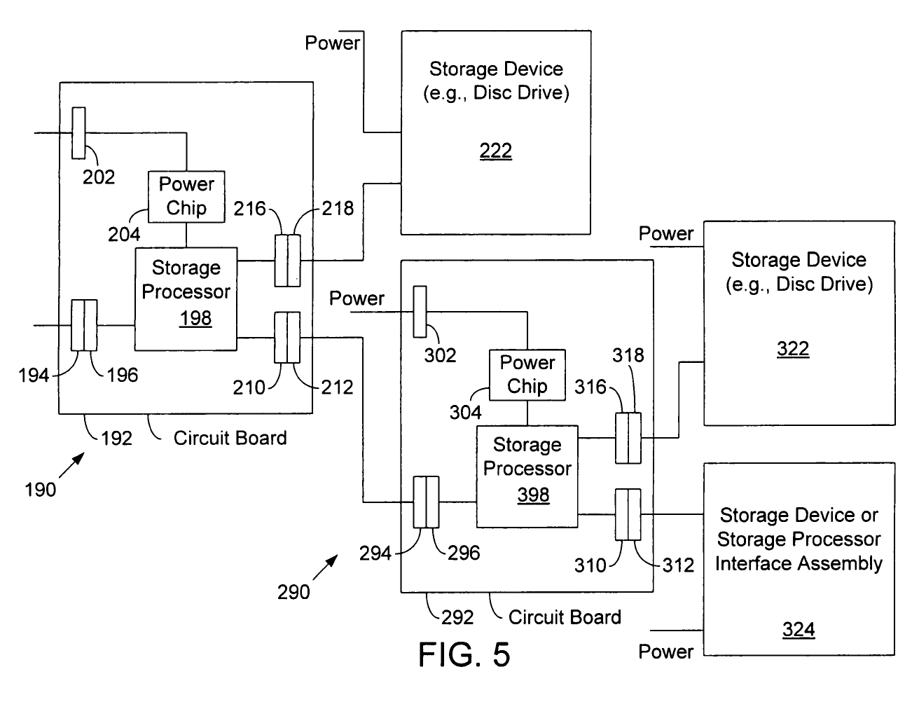

Referring to FIG. 5, a storage processor interface assembly 290 is coupled to connector 210 of storage processor interface assembly 190 through connectors 212 and 294. Storage processor interface assembly 290 may be identical to or different than storage processor interface assembly 190. Storage processor interface assembly 290 includes connectors 296, 302, 316, and 310 supported by a circuit board 292. Connector 296 is shown mated with connector 294 that carries data signals from storage processor interface assembly 190. Storage processor 398 provides the data signals from connector 296 to connector 316 and/or to connector 310 depending on the protocol. Connectors 316 and 310 are shown mated with connectors 318 and 312. Connector 318 may be part of storage device 322. Connector 312 may be part of storage device or storage processor interface assembly 324.

As mentioned above, the connectors may be SATA connectors. However, in other embodiments, some or all of the connectors are not SATA compatible.

B. Storage Processor Interface Assemblies Attached to Storage Devices

Storage processor interface assembly 20 may be implemented in a variety of ways. FIGS. 6-16 show various examples and views of a storage processor interface assembly 420, which is an example of storage processor interface assembly 20 of FIG. 1.

Referring to FIGS. 6-9, storage processor interface assembly 420 is attached to a hard disc drive 402, which has standard dimensions for a computer hard disc drive, and is an example of storage device 62. Storage processor interface assembly 420 includes a circuit board 418 (such as a printed circuit board) and is secured to disc drive 402 through a female SATA receptacle connector 500 (shown in FIGS. 7 and 9) that receives plugs from male SATA connectors of disc drive 402 (such as connectors 44 and 50 shown in FIG. 1, but not FIG. 6). Mechanical hold down features 476 and 478 pierce the circuit board to secure circuit board 418 to connector 500. Since circuit board 418 fits on the end of disc drive 402 that includes the drives male SATA connectors. In different embodiments, circuit board 418 has different dimensions. For example, in some embodiments, it has dimensions of about 22 millimeters (0.87 inches)×85 millimeters (3.35 inches). In other embodiments, circuit board 418 has dimensions that are less than 40 millimeters×100 millimeters. In still other embodiments, the circuit board 418 has dimensions that are less than 25 millimeters×90 millimeters. Still other dimensions could be used including combinations of those listed above.

Storage processor interface assembly 420 includes a male SATA data connector 424, a male SATA power connector 434, and a male SATA data connector 454 which are examples of connectors 24, 34, and 54 in FIG. 1. Guide ears or guide rails 480, 482, and 486 help with connections. A crystal 472 provides a clock which can be multiplied for use by storage processor 428, which is an example of storage processor 28 of FIG. 1. Power chips 438 and 454 provide power to the assembly. Right angle surface mount pins 490, 490, 502, and 504 are used to solder the connects to the circuit board through surface amount techniques.

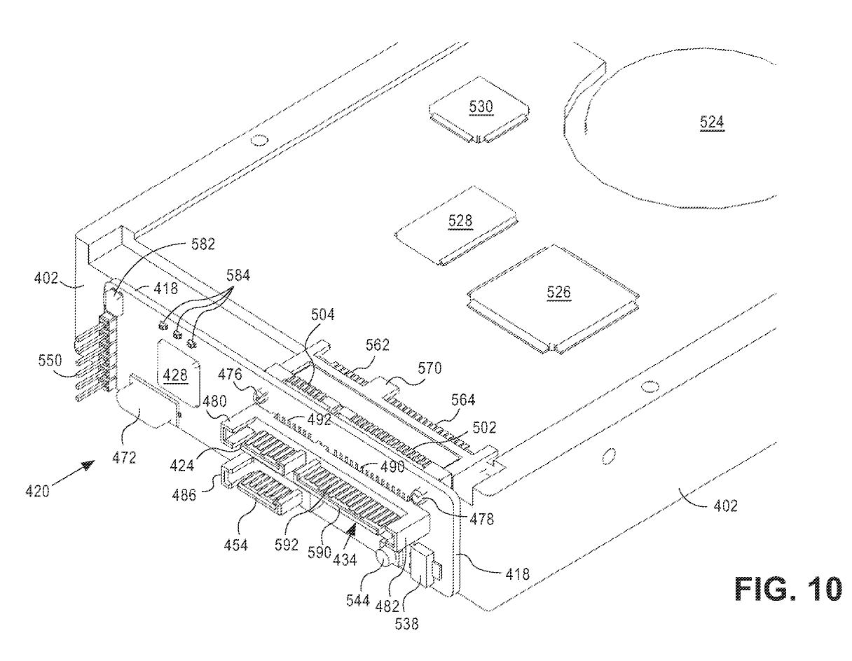

FIG. 10 shows a slightly different storage processor interface assembly 420 connected to disc drive 402, which is illustrated with a motor 524 and chips 526, 528, and 530. A connector support 570 with male SATA data connector 562 and male SATA power connector 564 are straddle mounted to disc drive 402. Connectors 562 and 564 are examples of connectors 50 and 44 in FIG. 1. Connector support 570 has a slot cut in it that slides over an edge of the circuit board. Bent pins 502 and 504 are part of connector 500. Bent pins 490, 492 are pins are surface mount contacts for bonding to the circuit board. Configuration pins 550 allow configuration through shorting pins together following a button 544 being pushed for a certain amount of time (for example, 10 seconds). Connector 434 includes pins 590 supported by a tongue 592. Capacitor 582 and light emitting diodes (LEDs) 584 are also supported by circuit board 418. Other items are identified in previous figures.

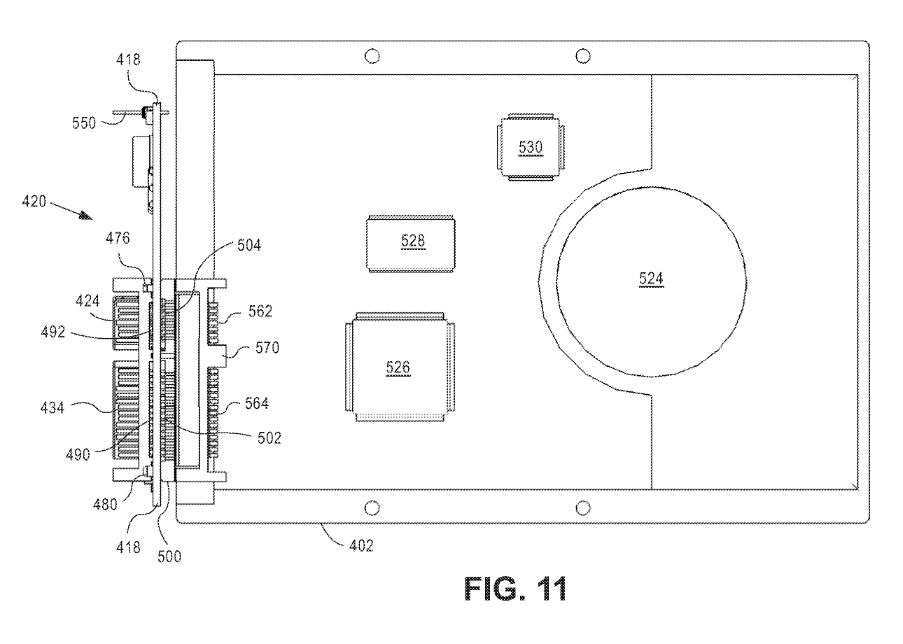

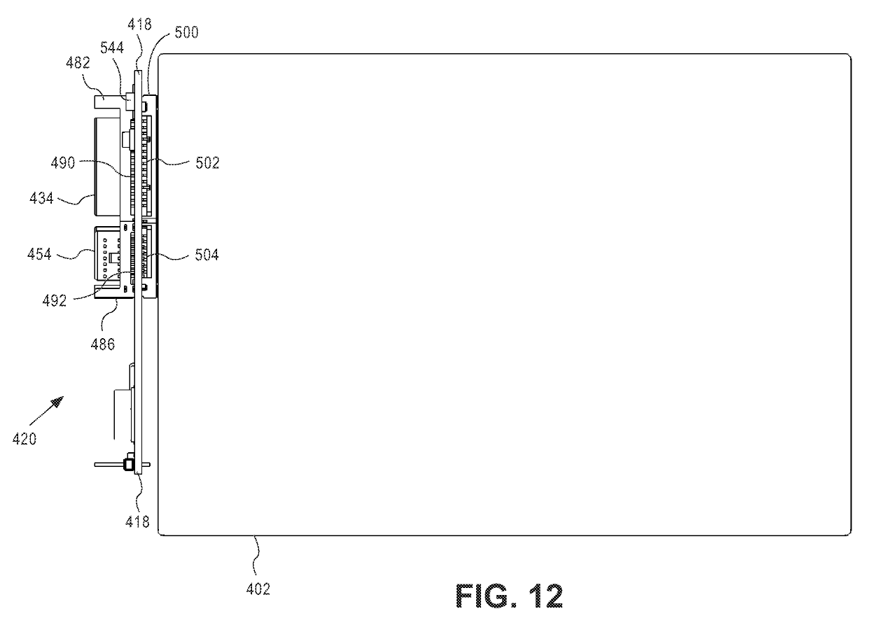

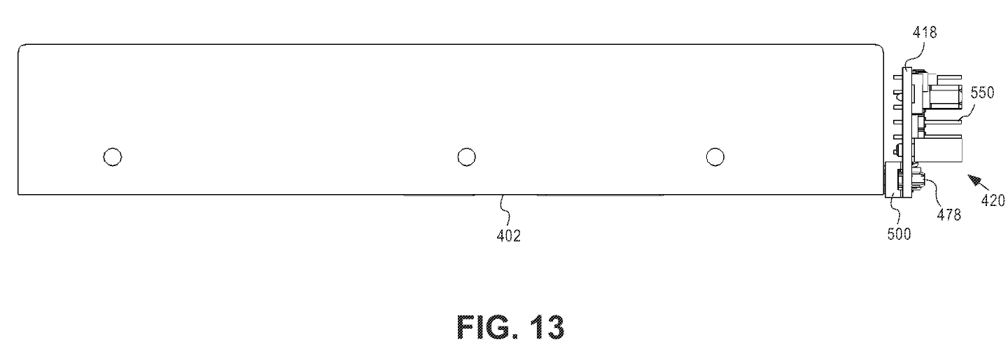

FIG. 11 provides a slightly different view than FIG. 10. If FIGS. 10 and 11 may be considered a bottom view of disc drive 402, FIG. 12 is the top view. FIG. 13 provides a side view of the system of FIGS. 10-12.

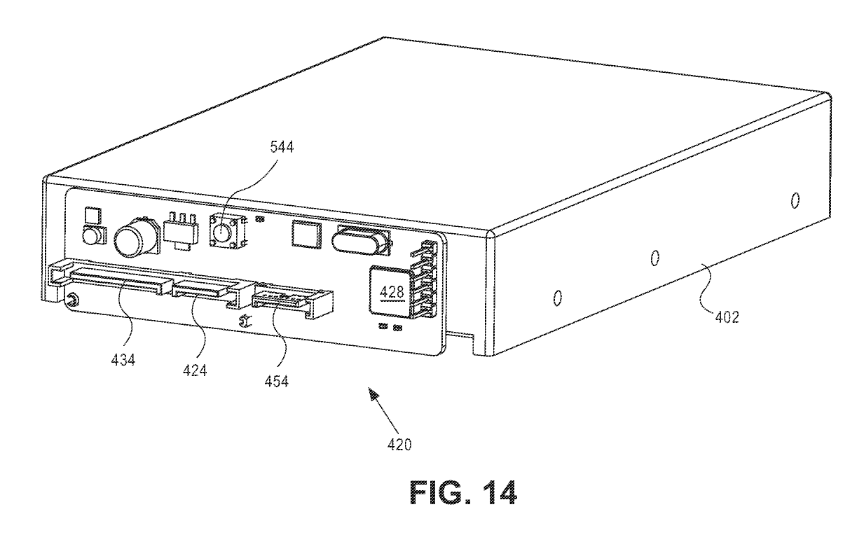

FIG. 14 has a storage processor interface assembly that is slightly different than that of FIGS. 7-9 and FIGS. 10-13 in the placement of connector 454. Note that receptacle connector 500 need not extend behind connector 454 because connector 454 is not in electrical contact with disc drive 402. However, it is not essential that connector 500 be directly behind connectors 434 and 424.

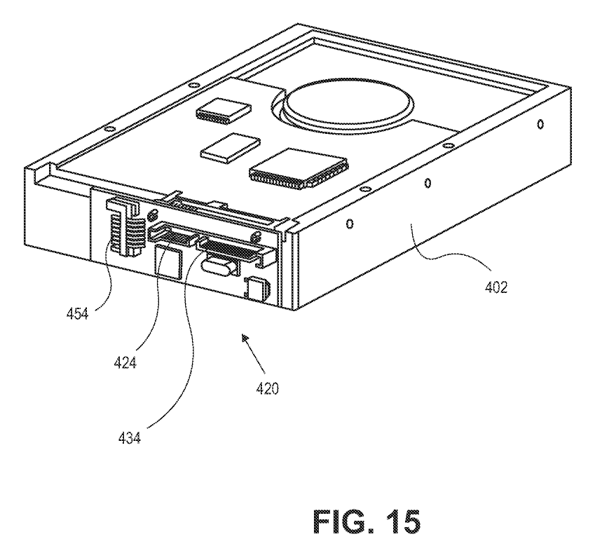

FIG. 15 has a storage processor interface assembly that is slightly different than that of FIGS. 7-9, FIGS. 10-13, and FIG. 14 in the placement of connector 454. In FIG. 15, connector 454 is a right angle surface mount connector.

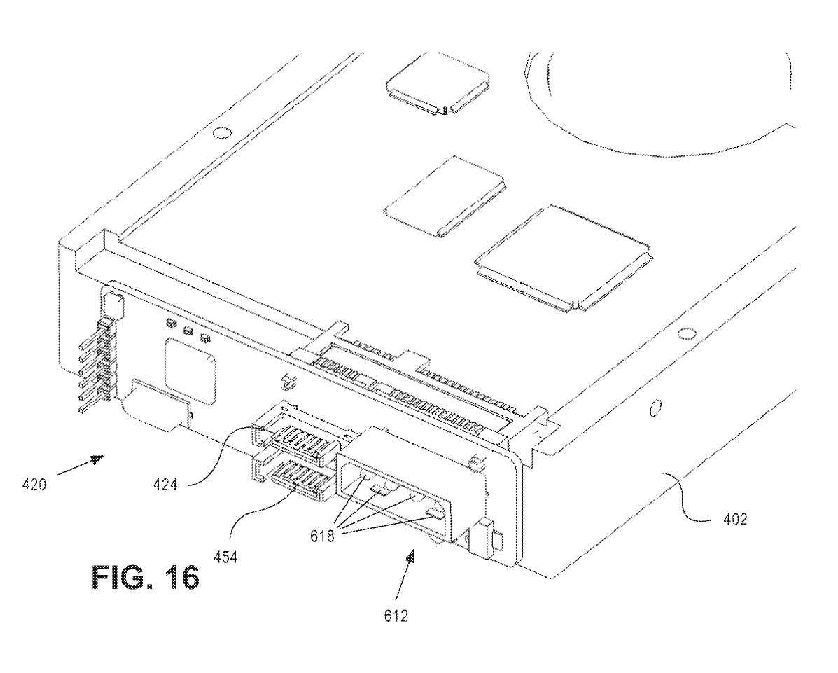

FIG. 16 has a storage processor interface assembly that is slightly different than that of FIGS. 7-9, FIGS. 10-13, FIG. 14, and FIG. 15 in that a legacy power connector 612 with four pints 618 are used rather than power connector 434.

C. Storage Processor Interface Assemblies in Enclosures

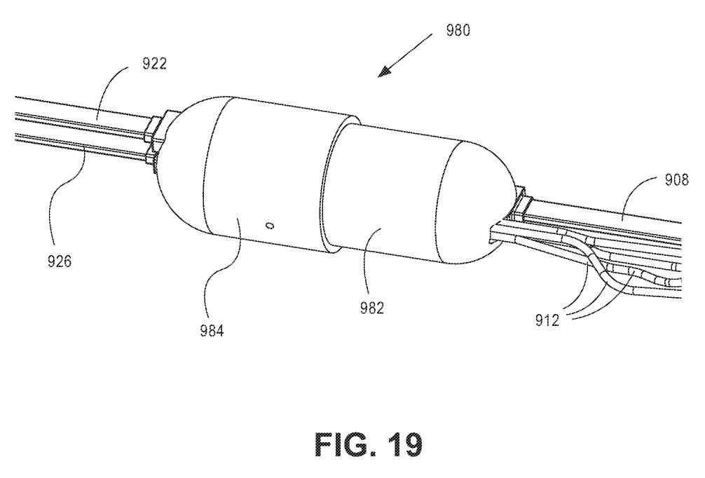

Storage processor interface assembly 190 may be implemented in a variety of ways. FIGS. 17 and 19 show enclosures in which storage processor interface assembly 190 may be placed. FIGS. 18 and 20-28 show various examples and views of a storage processor interface assembly 930, which is an example of storage processor interface assembly 190 of FIG. 4.

Referring to FIG. 17, an enclosure 902 includes a portion 904 and a portion 906 which join together. Portion 906 includes openings that allow internal connectors to receive a external connectors at the end of cables 908, 922, and 926, and for power wires 912. Power wires 912 may include a wire to carry 5 volts, a wire to carry 12 volts, and two ground wires, but that is not the case in some embodiments. The connectors may be compatible with internal or external (eSATA) SATA specifications. In some embodiments, the connectors are not SATA compatible.

FIG. 18 shows storage processor interface assembly 930, which is an example of a storage processor interface assembly that may be placed in enclosure 902. Storage processor interface assembly 930 includes a circuit board 932 that supports a male SATA connector 934 with a tongue 936 and a dual SATA male connector 956. Connector 934 is an example of connector 196 in FIG. 4 and dual connector 956 is an example of connectors 210 and 216 in FIG. 4. Receptacles 962 receive wires 912 (shown in FIG. 17). Also shown is storage processor 944 and power chip 938 (which are examples of storage processor 198 and power chip 204 in FIG. 4), crystal 946, configuration pins 950, and button 948.

FIG. 19 shows an alternative, generally cylindrically shaped, enclosure 980 including portions 982 and 984 for holding storage processor interface assembly 930.

In different embodiments, the enclosures may have different dimensions. Example dimensions for enclosure 902 and 980 are less than 100×100×200 millimeters, less than 50×50×100 millimeters, and less than 30×30×90 millimeters. The enclosures could have still other dimensions including combinations of those listed above.

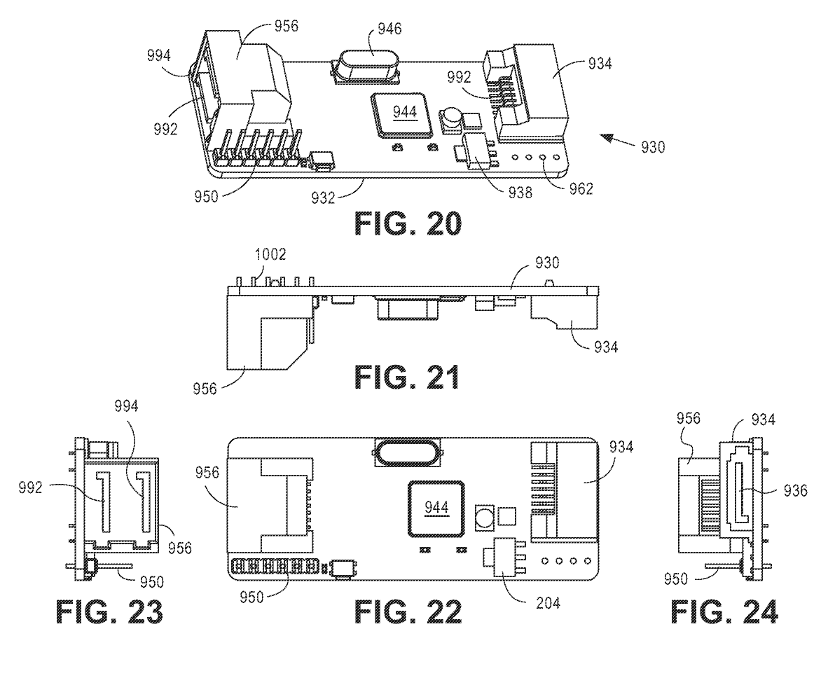

FIG. 20 shows the storage processor interface assembly 930 of FIG. 18 from a different view so that it illustrates tongues 992 and 994 of connector 956 and pins 992 of connector 934.

FIGS. 21-24 show other views of the storage processor interface assembly 930 of FIGS. 18 and 20. Pins 1002 are continuations of configuration pins 950.

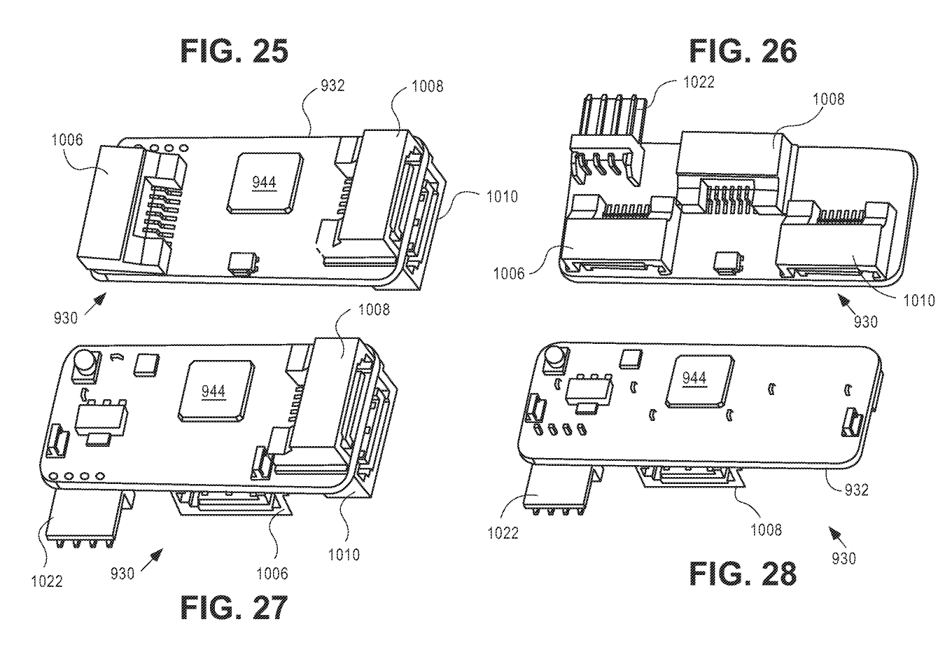

FIGS. 25-28 show variations of storage processor interface assembly 930 that are somewhat different than that of FIGS. 18 and 20-24 and that includes connectors 1006, 1008, and 1010 in different positions. Connectors 1006, 1008, and 1010 are examples of connectors 196, 210, and 216 in FIG. 4. A four pin power connector 1022 is included in FIGS. 26-28.

D. Other Information and Embodiments

In some embodiments, the storage processor interface assembly includes four data connectors to interface with a host and three storage devices or, for example, a host, two storage devices, and a storage processor interface assembly, or a host, a storage device and two storage processor interface assemblies. In some embodiments, the storage processor interface assembly may interface with two hosts.

There may be intermediate structure between various illustrated components. The various chips described or illustrated herein may have additional inputs or outputs which are not illustrated or described. In actual implementations of the systems of the figures, there would be additional circuitry, control lines, and perhaps interconnects which are not illustrated. When the figures show two blocks connected through conductors, there may be intermediate circuitry that is not illustrated. The shape and relative sizes of the blocks is not intended to relate to actual shapes and relative sizes.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments.

When it is said the element “A” is coupled to element “B,” element A may be directly coupled to element B or be indirectly coupled through, for example, element C.

When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.”

If the specification states a component, feature, structure, process, or characteristic “may”, “might”, or “could” be included, that particular component, feature, structure, process, or characteristic is not required to be included in all embodiments. If the specification or claim refers to “a” or “an” element, that does not mean there is only one of the element.

The inventions are not restricted to the particular details described herein. Indeed, many other variations of the foregoing description and drawings may be made within the scope of the present inventions. Accordingly, it is the following claims including any amendments thereto that define the scope of the inventions.

1. A storage processor interface assembly comprising:
a storage processor on a circuit board;
an input power connector and an output power connector, each attached to the circuit board and each standard compliant, the input power connector configured to carry a power signal from a host to the storage processor and the output power connector configured to pass through the power signal;
a plurality of standard compliant data connectors supported by the circuit board, the plurality including one input data connector configured to carry a data signal between a controller of the host and the storage processor and a plurality of output data connectors configured to carry a data signal between the storage processor and one or more storage devices;
wherein the storage processor is capable of operating with the plurality of output data connectors in at least one of a mirrored memory mode and a storage expansion mode.

2. The assembly of claim 1, wherein the circuit board has length dimensions that are less than 40 millimeters by 100 millimeters.

3. The assembly of claim 1, wherein an operating system of the host sees only one storage device coupled to the host controller when the output data connectors are configured to carry a data signal between the storage processor and a plurality of storage devices.

4. The assembly of claim 1, wherein the output power connector and a first output data connector are positioned at a distance from each other to match a standard compliant distance to mate with corresponding power and data connectors of one of the one or more storage devices.

5. The assembly of claim 1, wherein the output power connector and a first output data connector are positioned on a connector support attached to the circuit board.

6. The assembly of claim 1, wherein the input and output power connectors, and the plurality of data connectors are Serial Advanced Technology Attachment (SATA) compliant connectors.

7. The assembly of claim 1, wherein the input power and input data connectors are Serial Advanced Technology Attachment (SATA) compliant male connectors, and the output power and output data connectors are SATA compliant female connectors.

8. The assembly of claim 1, wherein at least one of the plurality of output data connectors is coupled to an input data connector of another storage processor interface assembly to provide a tree comprising a plurality of storage processors.

9. The assembly of claim 1, wherein the storage processor includes circuitry to change between operating with the plurality of output data connectors in the mirrored memory mode and operating in the storage expansion mode.

10. The assembly of claim 1, wherein the storage processor is capable of operating with the plurality of output data connectors in the mirrored memory mode, but not in the storage expansion mode.

11. The assembly of claim 1, wherein the storage processor is capable of operating with the plurality of output data connectors in the storage expansion mode, but not in the mirrored memory mode.

12. A storage processor interface assembly comprising:
an enclosure to hold a circuit board, the circuit board physically coupled to each of a storage processor, an input power connector and a plurality of standard compliant data connectors, wherein the enclosure includes openings such that the plurality of connectors are available to be mated with connectors of cables outside the enclosure;
wherein the input power connector is configured to carry a power signal from a host to the storage processor;
wherein the plurality of data connectors includes one input data connector configured to carry a data signal between a controller of the host and the storage processor and a plurality of output data connectors configured to carry a data signal between the storage processor and one or more storage devices;
wherein the storage processor is capable of operating with the plurality of output data connectors in at least one of a mirrored memory mode and a storage expansion mode; and
wherein the only data signal interfaces to the enclosure are the plurality of data connectors.

13. The assembly of claim 12, wherein the enclosure has length dimensions that are less than 50 millimeters by 50 millimeters by 100 millimeters.

14. A storage processor interface assembly comprising:
an enclosure to hold a circuit board, the circuit board physically coupled to each of a storage processor, an input power connector and a plurality of standard compliant data connectors, wherein the enclosure includes openings such that the plurality of connectors are available to be mated with connectors of cables outside the enclosure;
wherein the input power connector is configured to carry a power signal from a host to the storage processor;
wherein the plurality of data connectors includes one input data connector configured to carry a data signal between a controller of the host and the storage processor and a plurality of output data connectors configured to carry a data signal between the storage processor and one or more storage devices; and
wherein the storage processor is capable of operating with the second and third plurality of output data connectors in at least one of a mirrored memory mode and a storage expansion mode.

15. The assembly of claim 14, wherein the enclosure has length dimensions that are less than 50 millimeters by 50 millimeters by 100 millimeters.

16. The assembly of claim 14, wherein an operating system of the host sees only one storage device coupled to the host controller when the output data connectors are configured to carry a data signal between the storage processor and a plurality of storage devices.

17. The assembly of claim 14, wherein the enclosure has a generally cylindrical shape.

18. The assembly of claim 14, wherein the enclosure is generally a rectangular shape.

19. The assembly of claim 14, wherein the plurality of data connectors are Serial Advanced Technology Attachment (SATA) compliant male connectors.

20. The assembly of claim 14, wherein at least one of the plurality of output data connectors is coupled to an input data connector of another storage processor interface assembly to provide a tree comprising a plurality of storage processors.

21. The assembly of claim 14, wherein the storage processor includes circuitry to change between operating with the plurality of output data connectors in the mirrored memory mode and operating in the storage expansion mode.

22. A system comprising:
a first storage device including standard compliant power and data connectors rigidly affixed and spaced apart from one another; and
a storage processor interface assembly external to the first storage device comprising:
a circuit board supporting a storage processor;
an input power connector and an output power connector, each attached to the circuit board and each standard compliant, the input power connector configured to carry a power signal from a host to the storage processor and the output power configured to pass through the power signal;
a plurality of standard compliant data connectors supported by the circuit board, the plurality including one input data connector configured to carry a data signal between a controller of the host and the storage processor and a plurality of output data connectors configured to carry a data signal between the storage processor and one or more storage devices;
wherein the output power connector and a first output data connector are rigidly affixed to the circuit board and spaced apart from one another such that they mate with the power and data connectors of the first storage device; and
wherein the storage processor is capable of operating with the plurality of output data connectors in at least one of a mirrored memory mode and a storage expansion mode to mirror or partition the data signal output from the host controller between the first storage device and at least a second storage device.

23. The system of claim 22, wherein the circuit board has dimensions that are smaller than those of a side of the storage device to which the circuit board is coupled through the mating of the power and data connectors.

24. The system of claim 22, wherein the circuit board has length dimensions that are less than 40 millimeters by 100 millimeters.

25. The system of claim 22, wherein an operating system of the host sees only one storage device coupled to the host controller when the output data connectors are configured to carry a data signal between the storage processor and the first and the second storage device.

26. The system of claim 22, wherein the output power connector and the first output data connector are positioned at a distance from each other to match a standard compliant distance such that they can mate with the corresponding power and data connectors that are also at the standard compliant distance from each other.

27. The system of claim 22, wherein the input and output power connectors, and the plurality of data connectors are Serial Advanced Technology Attachment (SATA) compliant connectors.

28. The system of claim 22, wherein the storage processor includes circuitry to change between operating with the plurality of output data connectors in the mirrored memory mode and operating in the storage expansion mode.

29. The system of claim 22, further comprising a host computer with the host controller coupled to the input data connector, and with the second storage device coupled to a second output data connector.

30. The system of claim 22, further comprising a host computer with the host controller coupled to the first data connector, and a second storage processor interface assembly coupled to the third data connector to mirror or partition the data signal between the second storage device and at least a third storage device.

31. A system comprising:
first, second, and third cables each including first and second standard compliant data connectors;
a host computer with a host storage controller, the host storage controller mated with the first data connector of the first cable, and a first storage device coupled to the first data connector of the second cable; and
a storage processor interface assembly external to the first storage device and the host computer comprising:
an enclosure to hold a circuit board, the circuit board supporting each of a storage processor, an input power connector, and a plurality of standard compliant data connectors, wherein the enclosure includes openings such that the input power connector mates the storage processor with power from the host computer, a first connector of the circuit board mates the storage processor with the host storage controller via the second connector of the first cable, a second connector of the circuit board mates the storage processor with the first storage device via the second connector of the second cable, and a third connector of the circuit board mates the storage processor with at least a second storage device via the second connector of the third cable; and
wherein the storage processor is capable of operating with the second and third data connectors in at least one of a mirrored memory mode and a storage expansion mode to mirror or expand the data signal output from the host controller across the first storage device and at least a second storage device.

32. The system of claim 31, wherein the enclosure has length dimensions that are less than 50 millimeters by 50 millimeters by 100 millimeters.

33. The system of claim 31, wherein an operating system of the host sees only one storage device coupled to the host controller when the output data connectors are configured to carry a data signal between the storage processor and the first and the second storage device.

34. The system of claim 31, wherein the enclosure has a generally cylindrical.

35. The system of claim 31, wherein the enclosure is generally a rectangular shape.

36. The system of claim 31, wherein the plurality of data connectors are Serial Advanced Technology Attachment (SATA) compliant male connectors.

37. The system of claim 31, wherein the second storage device is coupled to the first connector of the third cable.

38. The system of claim 31, wherein the second storage processor interface assembly coupled to the first connector of the third cable.
